(19) United States
(12) Patent Application Publication
(10) Pub. No.: US 2015/0066840 A1
(43) Pub. Date: Mar. 5, 2015

(54) ANALYSIS SYSTEM

(71) Applicant: NEC Corporation, Minato-ku, Tokyo (JP)

(72) Inventors: Kazuya Koyama, Tokyo (JP); Yoichi Nagai, Tokyo (JP); Takeshi Arikuma, Tokyo (JP)

(73) Assignee: NEC CORPORATION

(21) Appl. No.: 14/389,808

(22) PCT Filed: Mar. 21, 2013
(86) PCT No.: PCT/JP2013/001918

§ 371 Date: Oct. 1, 2014

(30) Foreign Application Priority Data
Apr. 5, 2012 (JP) 2012-086362

(51) Int. Cl. G06F 17/30; H04N 5/262; G06K 9/00

(52) U.S. Cl. CPC G06F 17/30256; G06K 9/00536; H04N 5/262
USPC 707/603

(57) ABSTRACT

An analysis system 400 according to the present invention includes: an engine controlling part 410 configured to control an analysis operation of an analysis engine accepting input of analysis target data and executing an analysis process on the analysis target data; and an importance judging part 420 configured to judge the importance of an analysis result produced by a given analysis engine. The engine controlling part 410 includes a load change controlling part 411 configured to execute a load change process of changing a load on an analysis engine provided in the analysis system in the analysis process by the analysis engine, in accordance with a judgment result produced by the importance judging part.

### TECHNICAL FIELD

The present invention relates to an analysis system. More specifically, the present invention relates to an analysis system having a function of changing the load on an analysis engine analyzing inputted analysis target data.

### BACKGROUND ART

In recent years, various analysis engines that analyze data have been developed with development of information processing techniques. For example, various analysis engines, such as an analysis engine that generates position information for tracing the flow of a person from moving image data and an analysis engine that generates text data from speech data, have been developed.

An analysis system that is configured by a plurality of analysis engines of the same type or different types combined with each other and is capable of producing various analysis results from input data has also been developed. For example, a system that processes moving image data inputted from a camera in parallel or in series by using a flow extraction engine, a face extraction engine, an age estimation engine and so on and thereby judges a person of a predetermined behavior has been developed. Such an analysis system judging a person from data of a moving image captured by a camera is required to produce an analysis result speedily without delay, preferably, in real time from the time of input of analysis target data.
Patent Document 1: Japanese Unexamined Patent Application Publication No. 2004-200989

However, in a case where analysis target data are data continuously inputted and relatively large in volume, such as moving image data and speech data, the load of analysis executed by an analysis engines is heavy, and it is difficult to speedily obtain an analysis result. On the other hand, in a case where the volume of analysis target data is previously set small, for example, the frame rate of moving image data is previously set low, there arises a problem that desired accuracy of analysis cannot be obtained.

Patent Document 1 discloses a technique that an imaging device captures images at a low frame rate while no movement is detected and, when movement of a predetermined value or more is detected from the images being captured at the low frame rate, increases an imaging frame rate. This technique reduces the load of output of the result of processing by the imaging device acquiring analysis target data, but does not consider the load of analysis by an analysis engine configuring an analysis system. Moreover, because this technique does not consider the relation between analysis target data outputted from the imaging device and the accuracy of the result of analysis by the analysis engines, a case where desired accuracy cannot be achieved by the analysis engine may occur.

Thus, conventional analysis systems have a problem that it is difficult to speedily achieve desired accuracy with high accuracy while reducing the load on an analysis engine.

### SUMMARY

Accordingly, an object of the present invention is to solve the problem that it is difficult to speedily achieve desired accuracy with high accuracy while reducing the load on an analysis engine.

An analysis system as an aspect of the present invention includes:

an engine controlling part configured to control an analysis operation of an analysis engine accepting input of analysis target data and executing an analysis process on the analysis target data.

The engine controlling part includes:

an input data judging part configured to judge whether or not content of the analysis target data inputted into the analysis engine meets a preset judgment criterion; and

a load change controlling part configured to, when the input data judging part judges the content of the analysis target data meets the preset judgment criterion, execute a load change process set for the judgment criterion, the load change process being changing a load on the analysis engine in the analysis process by the analysis engine.

Further, a computer program as another aspect of the present invention is a computer program including instructions for causing an information processing device to realize an engine controlling part configured to control an analysis operation of an analysis engine accepting input of analysis target data and executing an analysis process on the analysis target data.

The engine controlling part includes:

an input data judging part configured to judge whether or not content of the analysis target data inputted into the analysis engine meets a preset judgment criterion; and

a load change controlling part configured to, when the input data judging part judges the content of the analysis target data meets the preset judgment criterion, execute a load change process set for the judgment criterion, the load change process being changing a load on the analysis engine in the analysis process by the analysis engine.

Further, an analysis method as another aspect of the present invention is an analysis method is an analysis method of accepting input of analysis target data, controlling an operation of an analysis engine, and executing an analysis process on the analysis target data.

The analysis method includes:

judging whether or not content of the analysis target data inputted into the analysis engine meets a preset judgment criterion; and

when the content of the analysis target data meets the preset judgment criterion, executing a load change process set for the judgment criterion, the load change process being changing a load on the analysis engine in the analysis process by the analysis engine.

Further, an analysis system as another aspect of the present invention includes:

an engine controlling part configured to control an analysis operation of an analysis engine accepting input of analysis target data and executing an analysis process on the analysis target data; and

an engine characteristics information storing part configured to store engine characteristics information representing, for each analysis engine, a relation between analysis accuracy of the analysis engine and a load change process of changing a load on the analysis engine in the analysis process by the analysis engine.

The engine controlling part includes a load change controlling part configured to execute the load change process associated with analysis accuracy of the analysis engine provided in the analysis system, based on the analysis accuracy of the analysis engine, the analysis accuracy being included in the engine characteristics information set for the analysis engine.

Further, a computer program as another aspect of the present invention is a computer program including instructions for causing an information processing device to realize an engine controlling part configured to control an analysis operation of an analysis engine accepting input of analysis target data and executing an analysis process on the analysis target data.

The information processing device includes an engine characteristics information storing part configured to store engine characteristics information representing, for each analysis engine, a relation between analysis accuracy of the analysis engine and a load change process of changing a load on the analysis engine in the analysis process by the analysis engine.

The engine controlling part includes a load change controlling part configured to execute the load change process associated with analysis accuracy of the analysis engine provided in the analysis system, based on the analysis accuracy of the analysis engine, the analysis accuracy being included in the engine characteristics information set for the analysis engine.

Further, an analysis method as another aspect of the present invention is an analysis method of accepting input of analysis target data, controlling an operation of an analysis engine, and executing an analysis process on the analysis target data.

The analysis method includes:

based on analysis accuracy included in engine characteristics information that is set for the analysis engine provided in the analysis system and that represents a relation between the analysis accuracy of the analysis engine and a load change process of changing a load on the analysis engine in the analysis process by the analysis engine, executing the load change process associated with the analysis accuracy.

Further, an analysis system as another aspect of the present invention includes:

an engine controlling part configured to control an analysis operation of an analysis engine accepting input of analysis target data and executing an analysis process on the analysis target data; and

an importance judging part configured to judge importance of an analysis result produced by a given analysis engine.

The engine controlling part includes a load change controlling part configured to execute a load change process of changing a load on an analysis engine provided in the analysis system in the analysis process by the analysis engine, in accordance with a judgment result produced by the importance judging part.

Further, a computer program as another aspect of the present invention includes instructions for causing an information processing device to realize:

an engine controlling part configured to control an analysis operation of an analysis engine accepting input of analysis target data and executing an analysis process on the analysis target data; and

an importance judging part configured to judge importance of an analysis result produced by a given analysis engine.

The engine controlling part includes a load change controlling part configured to execute a load change process of changing a load on an analysis engine provided in the analysis system in the analysis process by the analysis engine, in accordance with a judgment result produced by the importance judging part.

Further, an analysis method as another aspect of the present invention is an analysis method of accepting input of analysis target data, controlling an operation of an analysis engine, and executing an analysis process on the analysis target data.

The analysis method includes:

judging importance of an analysis result produced by a given analysis engine; and

executing a load change process of changing a load on an analysis engine provided in the analysis system in the analysis process by the analysis engine, in accordance with a judgment result produced by the importance judging part.

With the configurations as described above, the present invention can provide an analysis system capable of speedily producing an analysis result and achieving desired accuracy of analysis while reducing the load on the analysis engine.

### BRIEF DESCRIPTION OF DRAWINGS

FIG. 1 is a diagram showing the overview of the configuration of an analysis system according to the present invention;

FIG. 2 is a block diagram showing the configuration of an analysis system in a first exemplary embodiment of the present invention;

FIG. 3 is a diagram showing an example of the correspondence relation between input data and a load change process set in the analysis system in the first exemplary embodiment of the present invention;

FIG. 4 is a flowchart showing the operation of the analysis system in the first exemplary embodiment of the present invention;

FIG. 5 is a block diagram showing the configuration of an analysis system in a second exemplary embodiment of the present invention;

FIGS. 6A to 6C are diagrams each showing an example of the relation between a load reduction process and the accuracy of analysis set in the analysis system in the second exemplary embodiment of the present invention;

FIG. 7 is a flowchart showing the operation of the analysis system in the second exemplary embodiment of the present invention;

FIG. 8 is a block diagram showing the configuration of an analysis system in a third exemplary embodiment of the present invention;

FIG. 9 is a diagram showing an example of an importance judgment rule set in the analysis system in the third exemplary embodiment of the present invention;

FIG. 10 is a flowchart showing the operation of the analysis system in the third exemplary embodiment of the present invention;

FIG. 11 is a block diagram showing a configuration in Supplementary Note 1-1 of the present invention;

FIG. 12 is a block diagram showing a configuration in Supplementary Note 2-1 of the present invention; and

FIG. 13 is a block diagram showing a configuration in Supplementary Note 3-1 of the present invention.

### EXEMPLARY EMBODIMENTS

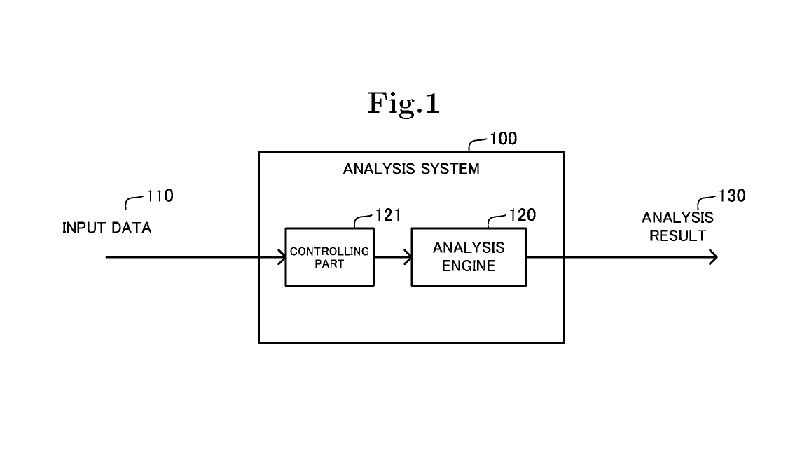

As shown in FIG. 1, an analysis system 100 according to the present invention includes an analysis engine 120 that executes a predetermined analysis process on input data 110, and outputs an analysis result 130 produced by the analysis engine 120. The analysis system 100 according to the present invention includes a controlling part 121 executing a load change process that is changing the load on the analysis engine 120 when the analysis engine 120 executes the analysis process.

Hereinafter, a case where the controlling part 121 of the analysis system 100 executes the load change process on the analysis engine 120 in accordance with the content of the input data 110 will be described as an example in a first exemplary embodiment, and a case where the controlling part 121 of the analysis system 100 executes the load change process in accordance with the characteristic of the analysis engine 120 will be described as an example in a second exemplary embodiment. Moreover, a case where the controlling part 121 of the analysis system 100 executes the load change process in accordance with the analysis result 130 produced by the analysis engine 120 will be described as an example in a third exemplary embodiment.

In each of the following exemplary embodiments, a description will be made assuming that analysis target data inputted into the analysis system 100, namely, the analysis engine 120 and analyzed by the analysis engine 120 is video data (stream data). However, analysis target data is not limited to video data, and may be other data such as speech data.

### First Exemplary Embodiment

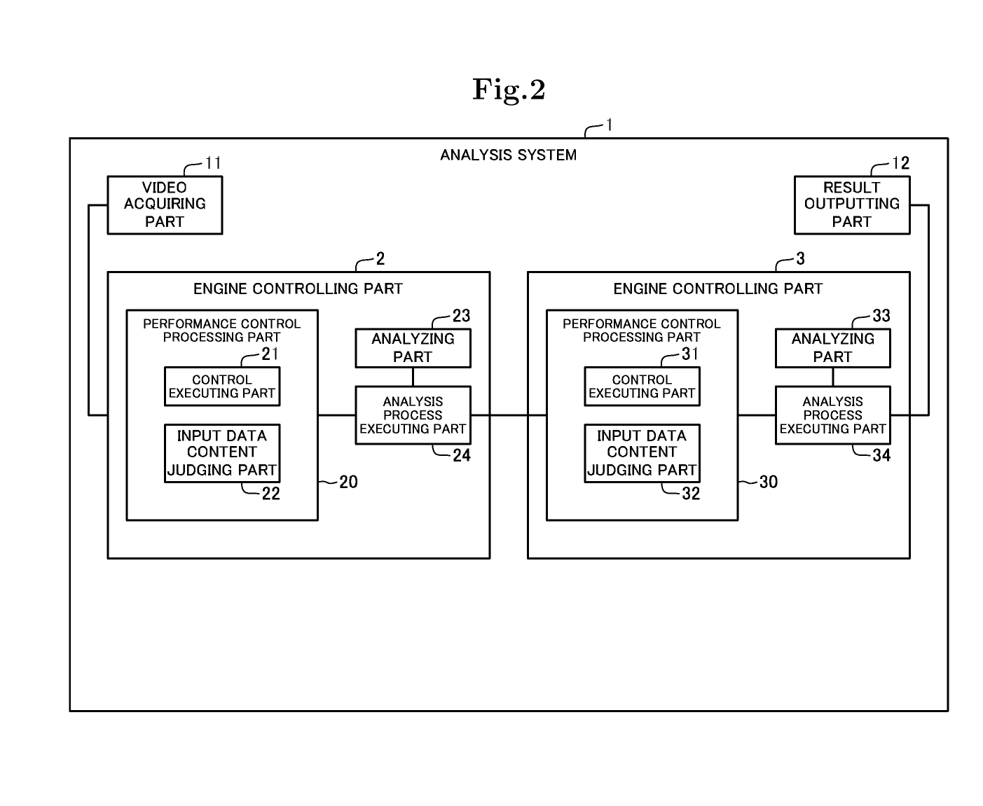

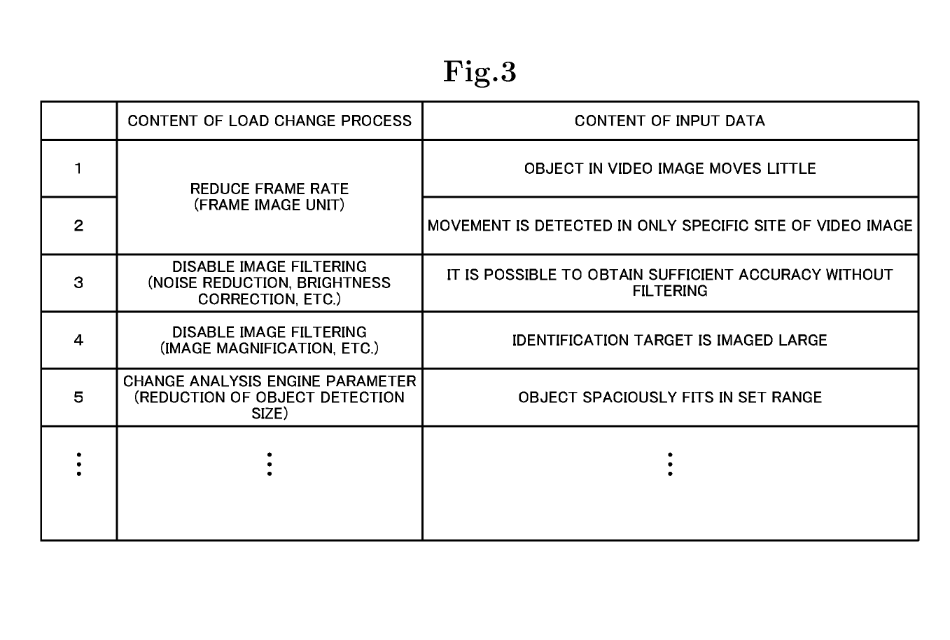

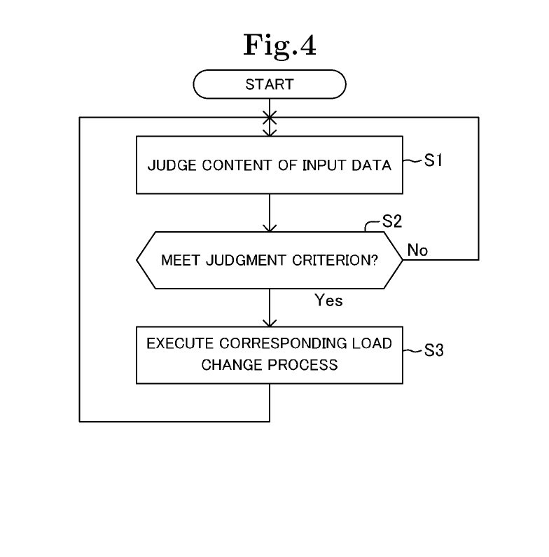

The first exemplary embodiment of the present invention will be described referring to FIGS. 2 to 4. FIGS. 2 and 3 are diagrams for describing the configuration of an analysis system in this exemplary embodiment, and FIG. 4 is a diagram for describing the operation of the analysis system.

An analysis system 1 shown in FIG. 1 is configured by one information processing device or a plurality of information processing devices. The analysis system 1 includes a video acquiring part 11 acquiring video data of analysis target data, engine controlling parts 2 and 3 each controlling to execute a predetermined analysis process, and a result outputting part 12 outputting analysis results produced by the engine controlling parts 2 and 3. Although FIG. 1 shows a case where the analysis system 1 includes the two engine controlling parts 2 and 3, the analysis system 1 may include more engine controlling parts or may include only one engine controlling part.

The engine controlling parts 2 and 3 respectively include: performance control processing parts 20 and 30 having control executing parts 21, 31 and input data content judging parts 22, 32, respectively; analyzing parts 23, 33; and analysis process executing parts 24, 34. Because the configurations of the engine controlling parts 2 and 3 in this exemplary embodiment are almost the same, only the configuration of the engine controlling part 2 will be described below.

First, the analyzing part 23 included by the engine controlling part 2 is an analysis engine whose operation is controlled by the analysis process executing part 24 and which executes a predetermined analysis process on video data of analysis target data acquired from the video acquiring part 11. In this exemplary embodiment, it is assumed that the analyzing part 23 is a flow extraction engine that tracks the flow of an object in video data, for example. However, the analyzing part 23 may be a face extraction engine that extracts the face of a person in video data, an age estimation engine that estimates the age of a person in video data, a person specification engine that specifies a person in video data, or the like.

Further, the input data content judging part 22 (an input data judging part) of the performance control processing part 20 included by the engine controlling part 2 judges whether or not the content of an input that is video data to be analyzed by the analyzing part 23 meets preset judgment criteria (step S1 in FIG. 4). An example of the preset judgment criteria is shown in FIG. 3. As shown in FIG. 3, in a judgment criterion, the content of input data is associated with a load change process that is changing the load on the analysis engine. In this case, a load change process set for each of the contents of input data is a preset process that does not influence on the accuracy of an analysis result produced by the analysis engine.

To be specific, the judgment criteria shown in FIG. 3 and processing by the input data content judging part 22 will be described in detail. In a judgment criterion denoted by “1” in FIG. 3, a load change process of “reducing the frame rate” of video data of input data and changing the processing load on the analyzing part 23 (the analysis engine) so as to decrease is associated with the content of input data, “an object in a video image moves little.” In this case, the input data content judging part 22 acquires the content of input data, and executes a process for judging whether or not the content meets the abovementioned judgment criterion. That is to say, firstly, in order to acquire the content of input data, the input data content judging part 22 executes a process of detecting an object based on a preset criterion from video data of input data and detecting the movement of the object. Then, in the case of being able to judge that “an object in a video image moves little” as set in the judgment criterion, for example, the acquired input data content, “the range of movement of an object,” is within a range of preset numerical values, the input data content judging part 22 judges that the content of the input data meets the judgment criterion (Yes at step S2 in FIG. 4). Moreover, the input data content judging part 22 notifies the content of the load change process, “reduce the frame rate,” in the judgment criterion associated with the input data content judged to meet the criterion, to the control executing part 21. In fact, in the load change process content, “reduce the frame rate,” a specific frame rate value reducing the frame rate is set.

Although a case where the input data content judging part 22 executes a process of acquiring the content of input data in order to judge whether or not the content of the input data meets a judgment criterion is shown in the above description, a processing result produced by another processing function provided in the analysis system 1 may be acquired as the content of input data. For example, the result of analysis of input data by the analyzing part 23 provided in the engine controlling part 2 described above may be acquired as the content of the input data.

Further, in a case where another analysis engine is provided in the preceding stage of the engine controlling part 2 described above, the input data content judging part 22 may acquire an analysis result produced by the other analysis engine as the content of input data. Moreover, the input data content judging part 22 may use accompanying information added to video data by the video acquiring part 11 arranged in the preceding stage of the engine controlling part 2 described above and acquire the content of input data of the video data. That is to say, in a case where the video acquiring part 11 is provided with a function of executing a predetermined process on captured video data and adding the result of the process as accompanying information to the video data, the input data content judging part 22 receives video data and accompanying information outputted from the video acquiring part 11, and acquires the content of the video data from the accompanying information.

A more specific example will be described. Because compression data is created depending on a difference between preceding and succeeding images according to a video compression technique defined by “H.264” or the like. By using this technique, when decoding a compressed video image, the video acquiring part 11 can add information of the difference between the images as accompanying information to a decoded video image. Then, the input data content judging part 22 can acquire “the range of movement of an object” that is an example of the content of input data described above, from the difference information of the accompanying information acquired together with the video data from the video acquiring part 11.

Thus, the input data content judging part 22 acquires the content of input data from a provided processing function such as the input data content judging part 22 or the video acquiring part 11, and judges whether or not the acquired input data content meets the judgment criterion. Then, the input data content judging part 22 notifies the content of a load change process in the judgment criterion associated with the content of the input data judged to meet the criterion, to the control executing part 21.

The control executing part 21 (a load change controlling part) executes the load change process of “reducing the frame rate” notified by the input data content judging part 22 (step S3 in FIG. 4). In this case, the control executing part 21 reduces the frame rate of video data of input data to be inputted into the analyzing part 23 (the analysis engine) so that the frame rate becomes a numerical value set in the judgment criterion.

Consequently, the data amount of video data of input data to be analyzed by the analyzing part 23 (the analysis engine) is reduced in the engine controlling part 2, so that it is possible to achieve decrease of the processing load on the analyzing part 23. On the other hand, because a value determined not to influence on the accuracy of an analysis result produced by the analyzing part 23 is set as a frame rate value to be reduced as described above, it is possible to obtain an analysis result with desired accuracy from the analysis system 1. For example, in a case where an object in a video image moves little, a probability that a person is moving is thought to be little, it can be said that there is no influence on an analysis result produced by the analyzing part 23 like a flow extraction engine. Thus, according to the analysis system 1 of this exemplary embodiment, it is possible to speedily obtain an analysis result with desired accuracy while reducing the load on the analysis engine.

The judgment criteria shown in FIG. 3 and another example of processing by the input data content judging part 22 will be described. In a judgment criterion denoted by “2” in FIG. 3, a load change process of “reducing the frame rate” of video data of input data and changing the processing load on the analyzing part 23 (the analysis engine) so as to decrease is associated with the content of input data that “movement of an object in a video image is detected in only a specific site of the video image.” In this case, the input data content judging part 22 executes a process for judging whether or not the content of input data meets the abovementioned judgment criterion. That is to say, firstly, the input data content judging part 22 detects an object from video data of input data and detects the movement of the object. Then, the input data content judging part 22 detects a site in the video image where the object is moving and, in the case of being able to judge the detected site is “only a preset site of the video image” set in the judgment criterion, judges that the content of the input data meets the judgment criterion. Moreover, the input data content judging part 22 notifies the content of the load change process, “reduce the frame rate” in the judgment criterion associated with the input data content judged to meet the criterion, to the control executing part 21. Then, as in the above description, the control executing part 21 (the load change controlling part) executes the load change process, “reduce the frame rate,” notified by the input data content judging part 22.

Consequently, because the data amount of video data of input data to be analyzed by the analyzing part 23 (the analysis engine) is decreased in the engine controlling part 2, it is possible to achieve decrease of the processing load on the analyzing part 23. On the other hand, because a value determined not to influence on the accuracy of an analysis result produced by the analyzing part 23 is previously set as a frame rate value to be reduced as described above, it is possible to obtain an analysis result with desired accuracy from the analysis system 1. For example, in a case where movement of an object in a video image is detected in only a place which a strictly monitored person usually comes in and out, a probability that a suspicious person enters is little, so that it can be said that there is no influence on an analysis result produced by the analyzing part 23 like a flow extraction engine. Thus, according to the analysis system 1 of this exemplary embodiment, it is possible to speedily obtain an analysis result with desired accuracy while reducing the load on the analysis engine.

Further, in a judgment criterion denoted by “3” shown in FIG. 3, a load change process of “disabling image filtering,” which is preprocessing executed on video data of input data before the analyzing part 23 (the analysis engine) processes the video data, and changing the load of processing on the analyzing part 23 so as to decrease is associated with the content of input data of quality that “it is possible to obtain sufficient accuracy without filtering.” Thus, a load change process associated with input data includes a process of changing the load of processing on the analyzing part 23 (the analysis engine).

The load change process of “disabling image filtering” associated with the content of the input data described above is an example of the load change process of changing preprocessing on video data. A load change process of “disabling other preprocessing,” or a load change process of “changing from predetermined preprocessing to other preprocessing” may be associated. For example, in a judgment criterion denoted by “4” shown in FIG. 3, a load change process of “disabling image filtering for magnifying an image,” which is preprocessing executed on video data of input data before the analyzing part 23 (the analysis engine) processes the video data, and changing the processing load on the analyzing part 23 (the analysis engine) so as to decrease is associated with the content of input data that “an object to be identified by the analyzing part 23 (the analysis engine) is imaged larger than a predetermined value.”

Further, in a judgment criterion denoted by “5” shown in FIG. 3, a load change process of “changing an analysis engine parameter” so as to reduce an object detection size that is a range where the analyzing part 23 (the analysis engine) analyzes video data of input data is associated with the content of image data that “an object spaciously fits in a set range (an object fits in a range of a predetermined proportion of a set range).” By thus reducing the object detection size of input data, it is possible to reduce the data amount of the input data, and it is possible to reduce the processing load on the analyzing part 23 (the analysis engine).

Thus, according to the analysis system of this exemplary embodiment, because the load change process on the analysis engine is executed in accordance with the content of analysis target data to be analyzed by the analysis engine, it is possible to speedily obtain an analysis result with desired accuracy of analysis while decreasing the load on the analysis engine.

### Second Exemplary Embodiment

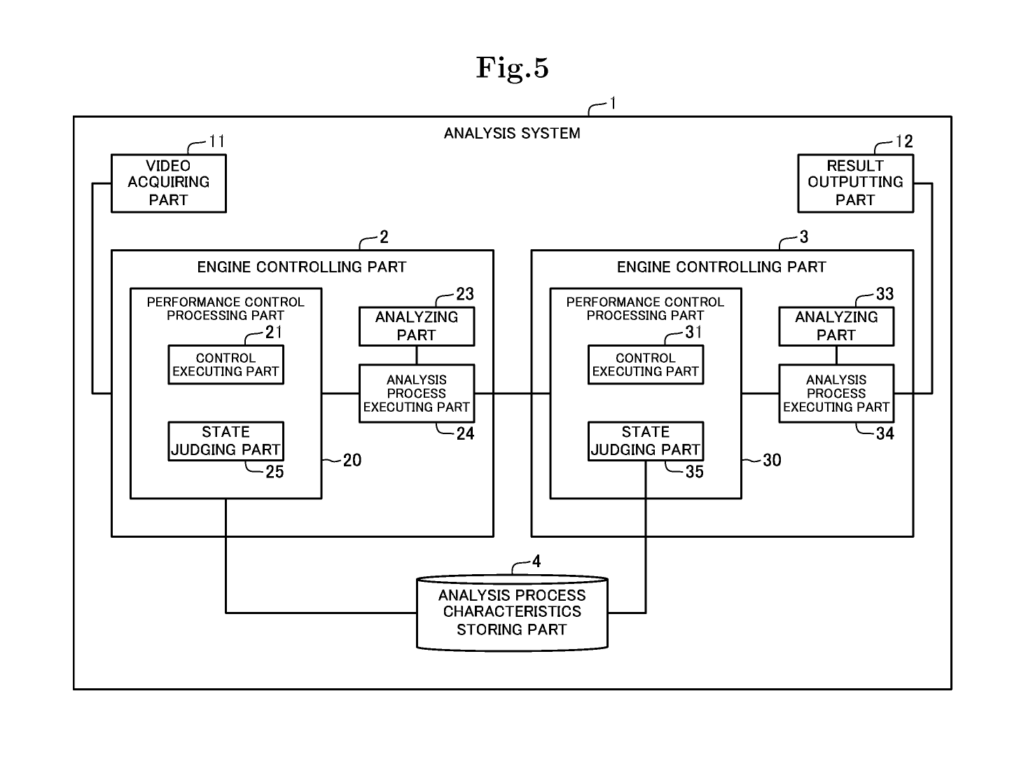

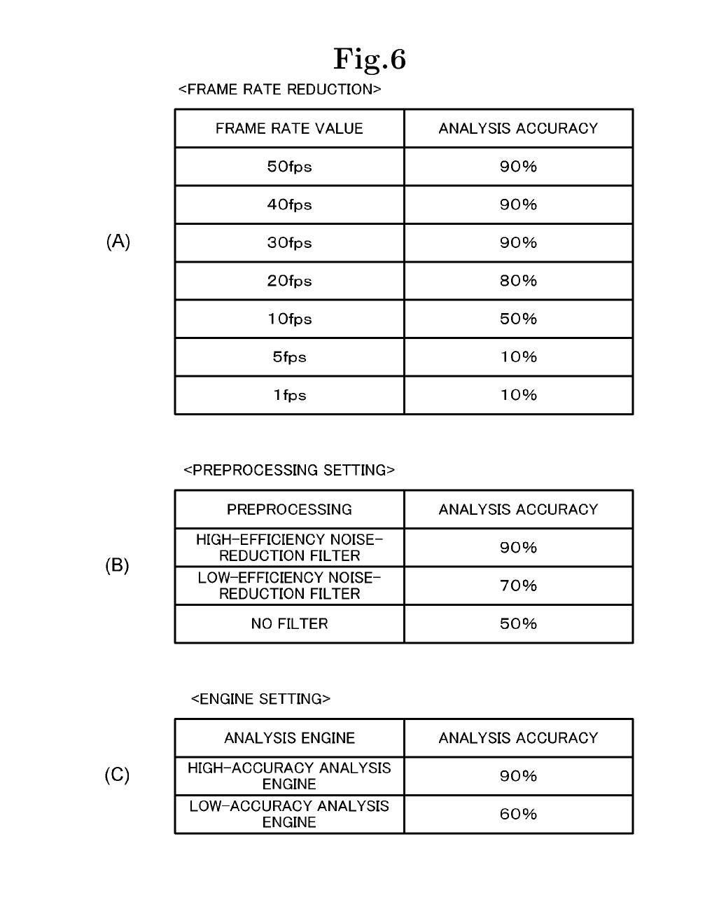

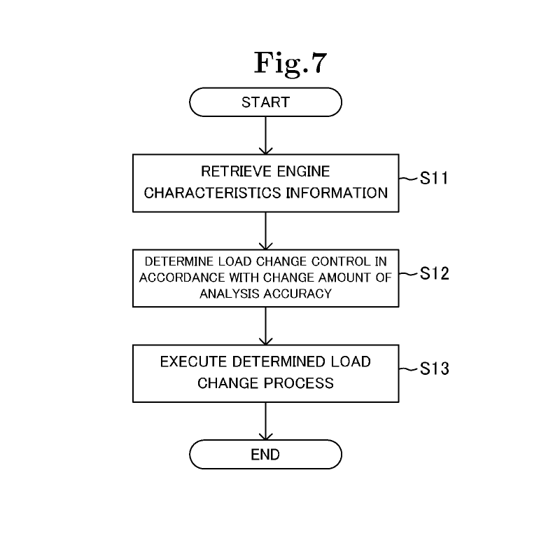

Next, a second exemplary embodiment of the present invention will be described referring to FIGS. 5 to 7. FIGS. 5 and FIGS. 6A to 6C are diagrams for describing the configuration of an analysis system in this exemplary embodiment, and FIG. 7 is a diagram for describing the operation of the analysis system.

The analysis system 1 shown in FIG. 5 is configured by one information processing device or a plurality of information processing devices. The analysis system 1 includes the video acquiring part 11 acquiring video data of analysis target data, the engine controlling parts 2 and 3 each controlling to execute a predetermined analysis process, the result outputting part 12 outputting analysis results produced by the engine controlling parts 2 and 3, and an analysis process characteristics storing part 4. Although FIG. 5 shows a case where the analysis system 1 includes the two engine controlling parts 2 and 3, the analysis system 1 may include more engine controlling parts or may include only one engine controlling part.

The engine controlling parts 2 and 3 respectively include: the performance control processing parts 20 and 30 having the control executing parts 21, 31 and state judging parts 25, 35, respectively; the analyzing parts 23, 33; and the analysis process executing parts 24, 34. Because the configurations of the engine controlling parts 2, 3 in this exemplary embodiment are almost the same, only the configuration of the engine controlling part 2 will be described below.

First, the analyzing part 23 included by the engine controlling part 2 is an analysis engine whose operation is controlled by the analysis process executing part 24 and which executes a predetermined analysis process on video data that is analysis target data acquired from the video acquiring part 11. In this exemplary embodiment, it is assumed that the analyzing part 23 is a flow extraction engine that tracks the flow of an object in video data, for example. However, the analyzing part 23 may be a face extraction engine that extracts the face of a person in video data, an age estimation engine that estimates the age of a person in video data, a person specification engine that specifies a person in video data, or the like.

Further, the state judging part 25 (the load change controlling part) of the performance control processing part 20 included by the engine controlling part 2 firstly retrieves analysis process characteristics information (engine characteristics information) representing the characteristics of the analyzing part 23 (the analysis engine) provided in the engine controlling part 2, from the analysis process characteristics storing part 4 (an engine characteristics information storing part) (step S11 in FIG. 7). Below, the analysis process characteristics information stored in the analysis process characteristics storing part 4 will be described.

The analysis process characteristics information is information which is previously set for each of the analysis engines, namely, for each of the analyzing parts 23 and which represents the relation between the analysis accuracy of an analysis result produced by the analyzing part 23 and a load change process of changing the load on the analyzing part 23. For example, in an example shown by FIG. 6A, the load change process is a process of “reducing the frame rate,” frame rate values by which the load change degrees differ are set as options for the load change process, and the analysis accuracy of an analysis result produced by the analyzing part 23 in a case where the load change process corresponding to each of the options is executed is associated. To be specific, analysis accuracy “90%” is set for a frame rate value “50 fps.” Likewise, analysis accuracy “90%” is set for a frame rate value “40 fps,” analysis accuracy “90%” is set for a frame rate value “30 fps,” analysis accuracy “80%” is set for a frame rate value “20 fps,” and analysis accuracy “50%” is set for a frame rate value “10 fps.”

Then, based on the abovementioned analysis process characteristics information, the state judging part 25 selects an option for a load reduction process that the accuracy of analysis satisfies a desired condition, and determines the load reduction process corresponding to the option (step S12 in FIG. 7). For example, in a case where the state judging part 25 operates so as to select an option by which it is possible to reduce the load with the least change amount of the analysis accuracy, the state judging part 25 selects an option of a frame rate value “30 fps” by which the accuracy of analysis is “90% and the change amount of the analysis accuracy is small,” and determines a load reduction process of controlling input data to the frame rate value. Besides, in a case where the requirement for the analysis accuracy of the analysis system 1 is previously set to 70% or more and it can be judged that the change amount is small when the analysis accuracy is 90% or 80%, the state judging part 25 may select an option of a frame rate value “20 fps.” Moreover, based on a preset requirement or a selection criterion set in the state judging part 25, another option may be selected. After that, the state judging part 25 notifies the content of a load change process corresponding to the option for the determined load change process, to the control executing part 21.

Then, the control executing part 21 (the load change controlling part) executes a load change process corresponding to the “frame rate value” notified by the state judging part 25 (step S13 of FIG. 7). In this case, the control executing part 21 decreases the frame rate of video data of input data to be inputted into the analyzing part 23 (the analysis engine) to the notified “frame rate value.”

Thus, because the data amount of video data of input data to be analyzed by the analyzing part 23 (the analysis engine) is reduced in the engine controlling part 2, it is possible to reduce the load of processing by the analyzing part 23. On the other hand, because the frame rate is set so as to satisfy analysis accuracy corresponding to the frame rate value decreased as described above, it is possible to obtain an analysis result with desired accuracy from the analysis system 1.

The analysis process characteristics information is not limited to the example shown in FIG. 6A described above. For example, as shown in FIG. 6B, in a case where the load change process is “setting preprocessing on input data to be inputted into the analyzing part 23 (the analysis engine),” “kinds of preprocessing” by which the degrees of change of the load on the analyzing part 23 differ are set as options for the load change process, and the analysis accuracy of an analysis result produced by the analyzing part 23 when the load change process is executed is set in accordance with the options. To be specific, analysis accuracy “90%” is set for a case where a “high-efficiency noise-reduction filter” is used in preprocessing. Likewise, analysis accuracy “70%” is set for a case where a “low-efficiency noise-reduction filter” is used in preprocessing, and analysis accuracy “50%” is set for a case where “no filter” is used in preprocessing.

In a case where the analysis process characteristics information described above is set, for example, assuming that the requirement for the analysis accuracy in the analysis system 1 is previously set to 70% or more, the state judging part 25 selects an option of “a low-efficiency noise-reduction filter” for preprocessing that enables analysis with analysis accuracy “70%,” and determines a load reduction process of controlling so as to execute preprocessing on input data with the filter.

In a case where both the analysis process characteristics information shown in FIG. 6A and the analysis process characteristics information shown in FIG. 6B are set, the state judging part 25 may select only the option for the load reduction process set in either of the analysis process characteristics information, or may respectively select the options for the load reduction processes set in both the analysis process characteristics information and execute both the load reduction processes corresponding to the options, respectively. For example, assuming that the requirement for the analysis accuracy in the analysis system 1 is previously set to 70% or more, the state judging part 25 selects the option of the frame rate value “20 fps” corresponding to the analysis accuracy “80%” from FIG. 6A, and selects the option of “low-efficiency noise-reduction filter” for preprocessing corresponding to the analysis accuracy “70%” from FIG. 6B. Then, the state judging part 25 may execute the load reduction processes corresponding to both the options, or may select only one of the options and execute only the load reduction process corresponding to the option.

Further, as another example of the analysis process characteristics information, for example, as shown in FIG. 6C, in a case where a load change process is “setting an analysis engine used for analysis in the analyzing part 23,” “kinds of analysis engines” by which the degrees of change of the load on the analyzing part 23 differ are set as options for the load change process, and the analysis accuracy of an analysis result produced by the analyzing part 23 when the load change process is executed is set in accordance with the options. To be specific, analysis accuracy “90%” is set for a case where “a high-accuracy analysis engine” is used as the analysis engine. Likewise, analysis accuracy “60%” is set for a case where “a low-accuracy analysis engine” is used as the analysis engine.

In a case where the analysis process characteristics information described above is set, for example, assuming that the requirement for the analysis accuracy in the analysis system 1 is previously set to 60% or more, the state judging part 25 selects an option of “a low-accuracy analysis engine” that is an analysis engine enabling analysis with analysis accuracy “60%,” and determines a load reduction process of controlling so as to execute analysis of input data with the analysis engine.

The load change processes set in the analysis process characteristics information described above are examples, and may be other processes. For example, the load change process may be a process of dividing video data and changing the value of the frame rate of the partial division image. Moreover, the load change process may be a process of changing an execution parameter set in the analysis engine, for example an execution parameter such as a threshold of the size of an object to be identified in video data.

Thus, according to the analysis system of this exemplary embodiment, because the load change process on the analysis engine is executed in accordance with the characteristics of the analysis engine, it is possible to speedily obtain an analysis result with desired analysis accuracy while decreasing the load on the analysis engine.

### Third Exemplary Embodiment

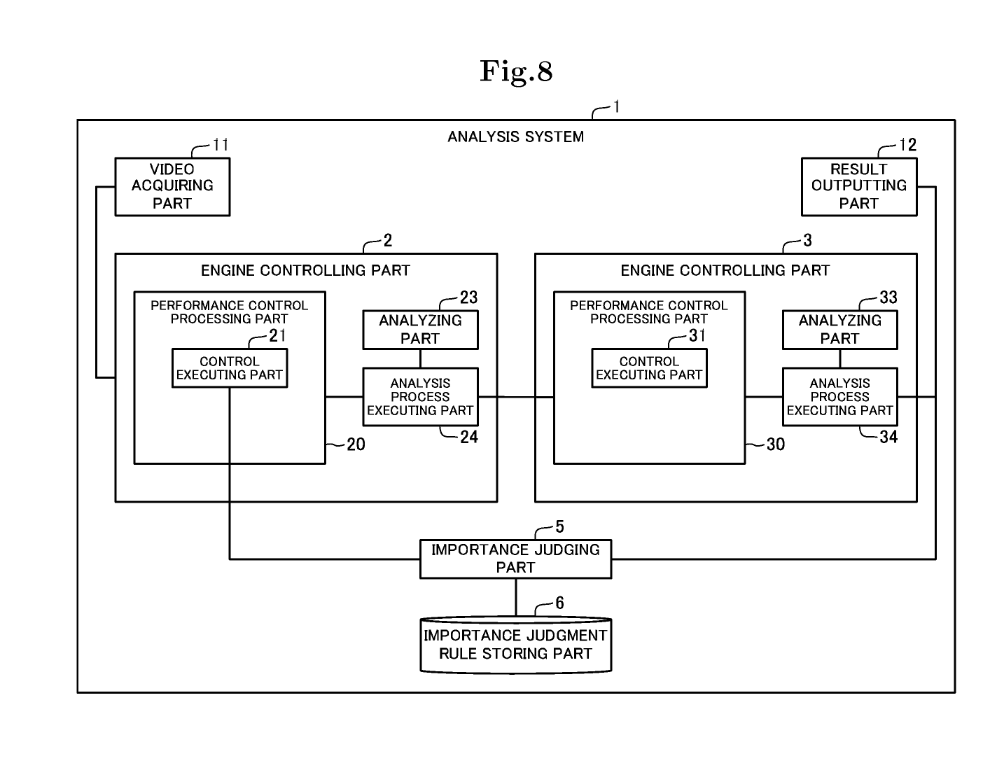

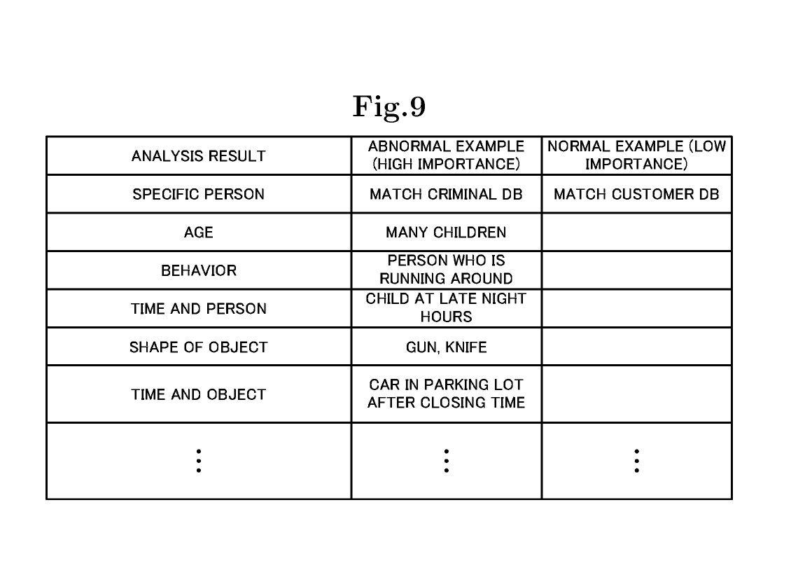

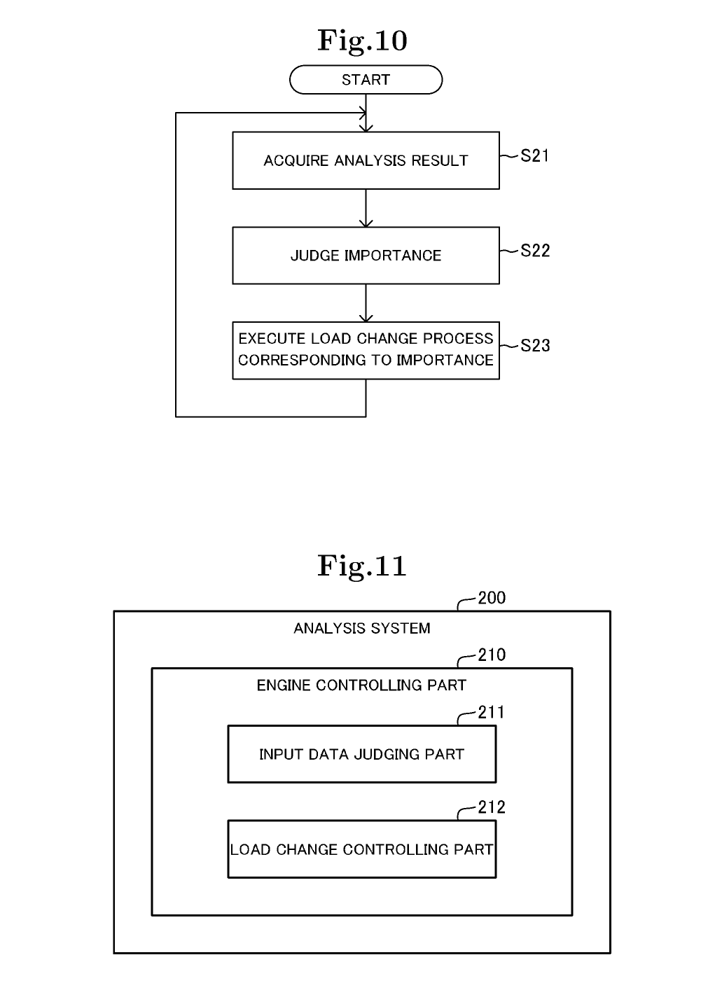

Next, a third exemplary embodiment of the present invention will be described referring to FIGS. 8 to 10. FIGS. 8 and 9 are diagrams for describing the configuration of an analysis system in this exemplary embodiment, and FIG. 10 is a diagram for describing the operation of the analysis system.

The analysis system 1 shown in FIG. 8 is configured by one information processing device or a plurality of information processing devices. The analysis system 1 includes the video acquiring part 11 acquiring video data of analysis target data, the engine controlling parts 2 and 3 each controlling to execute a predetermined analysis process, the result outputting part 12 outputting analysis results produced by the engine controlling parts 2 and 3, an importance judging part 5, and an importance judgment rule storing part 6. Although FIG. 8 shows a case where the analysis system 1 includes the two engine controlling parts 2 and 3, the analysis system 1 may include more engine controlling parts or may include only one engine controlling part.

The engine controlling parts 2 and 3 respectively include: the performance control processing parts 20, 30 having the control executing parts 21, 31, respectively; the analyzing parts 23, 33; and the analysis process executing parts 24, 34. The engine controlling parts 2, 3 are provided in a manner that the engine controlling part denoted by reference numeral 2 is located in the preceding stage and the engine controlling part denoted by reference numeral 3 is located in the succeeding stage. Although the configurations of the engine controlling parts 2, 3 in this exemplary embodiment are almost the same, the contents of analysis processes are difference as described below.

First, the analyzing parts 23, 33 included by the engine controlling parts 2, 3, respectively, are analysis engines which are controlled by the analysis process executing parts 24, 34 and which execute predetermined analysis processes on video data of analysis target data acquired from the video acquiring part 11. For example, it is assumed that the analyzing part 23 included by the engine controlling part 2 in the preceding stage is a flow extraction engine that tracks the flow of an object in video data and the analyzing part 33 included by the engine controlling part 3 in the succeeding stage is an object extraction engine that specifies a person or an object in video data. However, the analyzing parts 23, 33 included by the engine controlling parts 2, 3, respectively, may be any analysis engines.

Further, in accordance with a judgment result produced by the importance judging part 5, the control executing part 21 (the load change controlling part) of the performance control processing part 20 included by the engine controlling part 2 executes a load change process corresponding to the judgment result as described later. This process will be described in detail later.

The importance judging part 5 and the importance judgment rule storing part 6 will be described. The importance judging part 5 firstly acquires an analysis result produced by the analyzing part 33 (the analysis engine) of the engine controlling part 3 in the succeeding stage (step S21 in FIG. 10). Subsequently, the importance judging part 5 judges the importance of the acquired analysis result based on information stored in the importance judgment rule storing part 6 (step S22 in FIG. 10).

In this case, in the importance judgment rule storing part 6 (an importance judgment criterion storing part), an abnormal example to which high importance is set and a normal example to which low importance is set among analysis results are stored as shown in FIG. 9. For example, in a case where “a specific person” of an analysis result “matches a criminal DB (database),” “high importance” is set. In this case, in a case where “a specific person” of an analysis result produced by the analyzing part 33 (the analysis engine) of the engine controlling part 3 in the succeeding stage is a person recorded in “the criminal DB (database),” the importance judging part 5 judges as “high importance.” Moreover, in the importance judgment rule storing part 6, as another example, “a time and a person” of an analysis result is “a child at late night hours,” “high importance” is set. In this case, in a case where “a time and a person” as an analysis result produced by the analyzing part 33 of the engine controlling part 3 in the succeeding stage is “a child at late night hours,” the importance judging part 5 judges as “high importance.” In the examples of the information stored in the importance judgment rule storing part 6 shown in FIG. 9, the importance decrees of the respective analysis results are represented by two grades of “high” and “low,” but the importance degrees of the respective analysis results may be represented by a plurality of grades. In accordance with this, the importance judging part 5 may judge the importance decrees of predetermined grades from the analysis results.

Then, the importance judging part 5 notifies an importance judgment result to the control executing part 21 of the engine controlling part 2 in the preceding stage. In response to this, the control executing part 21 of the engine controlling part 2 in the preceding stage executes a load change process on the analyzing part 23 (the analysis engine) corresponding to the notified judgment result (step S23 in FIG. 10). At this time, as the notified importance is higher, the control executing part 21 executes a load change process that the load on the analyzing part 23 is higher but the accuracy of analysis by the analyzing part 23 is higher. On the other hand, as the notified importance is lower, the control executing part 21 executes a load change process that the accuracy of analysis by the analyzing part 23 is lower but the load on the analyzing part 23 is lower. For example, the control executing part 21 controls so that the frame rate of video data of input data is higher as the notified importance is higher, and controls so that the frame rate of the video data is lower as the importance is lower. The content of the load change process executed in accordance with the importance is prepared as information that is previously associated with the importance and stored so that the control executing part 21 can refer to.

Thus, in the engine controlling part 2, when the importance of an analysis result is low, the data amount of video data of input data to be analyzed by the analyzing part 23 (the analysis engine) is decreased, and therefore, it is possible to decrease the load of processing by the analyzing part 23. On the other hand, when the importance of an analysis result is high, the data amount of video data of input data to be analyzed by the analyzing part 23 (the analysis engine) is increased, and therefore, it is possible to obtain an analysis result with desired accuracy of analysis.

The load change process corresponding to the importance is not limited to the abovementioned process. For example, the load change process may be a process of changing or disabling a preset process executed on video data of input data by the analyzing part 23 (the analysis engine). To be specific, in a case where the analyzing part 23 executes an analysis process of detecting a person, when the importance of a target analysis result is judged low, the analyzing part 23 may omit the analysis process of detecting a person or may execute the analysis process after decreasing the frame rate of input data to become the target of detection of a person.

Thus, according to the analysis system of this exemplary embodiment, because a load change process on an analysis engine in the preceding stage is executed in accordance with an analysis result produced by a predetermined analysis engine, it is possible to speedily obtain an analysis result with desired accuracy of analysis while reducing the load on the analysis engine.

The analysis system described in each of the above exemplary embodiments can also execute control to change the load on an analysis engine based on other information. For example, based on preset environmental information such as information representing the mounted position and mounted angle of a camera configuring the video acquiring part 11, the analysis system controls to execute a load change process on an analysis engine, such as decreasing the frame rate of video data acquired by the camera.

As a specific example of the above description, it is considered to execute control to reduce the load on an analysis engine, such as decreasing the frame rate, on video data captured by a camera mounted at a position and an angle where it is possible to acquire only video data such that it is possible to judge that an object in the video data moves little at all times. Moreover, it is also considered to execute control to reduce the load on an analysis engine, such as decreasing the frame rate of the overlapping region in the video data or deleting the overlapping region, on video data captured by a camera mounted at a position and an angle where an imaging region overlaps with that of another camera.

Further, the analysis system may previously store sample video data as video data acquired by the video acquiring part 11, generate environmental information representing the mounted position and mounted angle of the camera configuring the video acquiring part 11 from the sample video data, and control to execute the load change process on the analysis engine in the same manner as described above based on the environmental state.

### <Supplementary Notes>

The whole or part of the exemplary embodiments disclosed above can be described as the following supplementary notes. Below, the overview of the configurations of an analysis system (see FIGS. 11, 12 and 13), a program, and an analysis method according to the present invention will be described. However, the present invention is not limited to the following configurations

### (Supplementary Note 1-1: see FIG. 11)

An analysis system 200 comprising:

an engine controlling part 210 configured to control an analysis operation of an analysis engine accepting input of analysis target data and executing an analysis process on the analysis target data,

wherein the engine controlling part 210 includes:
an input data judging part 211 configured to judge whether or not content of the analysis target data inputted into the analysis engine meets a preset judgment criterion; and
a load change controlling part 212 configured to, when the input data judging part judges the content of the analysis target data meets the preset judgment criterion, execute a load change process set for the judgment criterion, the load change process being changing a load on the analysis engine in the analysis process by the analysis engine.

### (Supplementary Note 1-2)

The analysis system according to Supplementary Note 1-1, wherein:

the input data judging part is configured to judge whether or not content of the analysis target data inputted into the analysis engine meets the judgment criterion that content of the analysis target data is associated with the load change process that is preset so as not to influence accuracy of an analysis process result produced by the analysis engine; and

the load change controlling part is configured to execute the load change process associated with the content of the analysis target data, the content being judged to meet the judgment criterion by the input data judging part.

### (Supplementary Note 1-3)

The analysis system according to Supplementary Note 1-1 or 1-2, wherein the input data judging part is configured to acquire content of the analysis target data outputted by processing of the analysis target data by a predetermined processing function provided in the analysis system, and judge whether or not the acquired content of the analysis target data meets the judgment criterion.

### (Supplementary Note 1-4)

The analysis system according to any of Supplementary Notes 1-1 to 1-3, wherein the load change process is a process of reducing a data amount of the analysis target data.

### (Supplementary Note 1-5)

The analysis system according to Supplementary Note 1-4, wherein the load change process is a process of reducing a frame rate of the analysis target data.

### (Supplementary Note 1-6)

The analysis system according to Supplementary Note 1-4, wherein the load change process is a process of limiting a range of the analysis process on the analysis target data by the analysis engine.

### (Supplementary Note 1-7)

The analysis system according to any of Supplementary Notes 1-1 to 1-6, wherein the load change process is a process of changing preprocessing executed on the analysis target data before the analysis engine processes the analysis target data.

### (Supplementary Note 1-8)

A computer program comprising instructions for causing an information processing device to realize an engine controlling part configured to control an analysis operation of an analysis engine accepting input of analysis target data and executing an analysis process on the analysis target data,

wherein the engine controlling part includes:
an input data judging part configured to judge whether or not content of the analysis target data inputted into the analysis engine meets a preset judgment criterion; and
a load change controlling part configured to, when the input data judging part judges the content of the analysis target data meets the preset judgment criterion, execute a load change process set for the judgment criterion, the load change process being changing a load on the analysis engine in the analysis process by the analysis engine.

### (Supplementary Note 1-9)

The computer program according to Supplementary Note 1-8, wherein:

the input data judging part is configured to judge whether or not content of the analysis target data inputted into the analysis engine meets the judgment criterion that content of the analysis target data is associated with the load change process that is preset so as not to influence accuracy of an analysis process result produced by the analysis engine; and

the load change controlling part is configured to execute the load change process associated with the content of the analysis target data, the content being judged to meet the judgment criterion by the input data judging part.

### (Supplementary Note 1-10)

An analysis method of accepting input of analysis target data, controlling an operation of an analysis engine, and executing an analysis process on the analysis target data, the analysis method comprising:

judging whether or not content of the analysis target data inputted into the analysis engine meets a preset judgment criterion; and

when the content of the analysis target data meets the preset judgment criterion, executing a load change process set for the judgment criterion, the load change process being changing a load on the analysis engine in the analysis process by the analysis engine.

### (Supplementary Note 1-11)

The analysis method according to Supplementary Note 1-10, comprising:

judging whether or not content of the analysis target data inputted into the analysis engine meets the judgment criterion that content of the analysis target data is associated with the load change process that is preset so as not to influence accuracy of an analysis process result produced by the analysis engine; and

executing the load change process associated with the content of the analysis target data, the content being judged to meet the judgment criterion by the input data judging part.

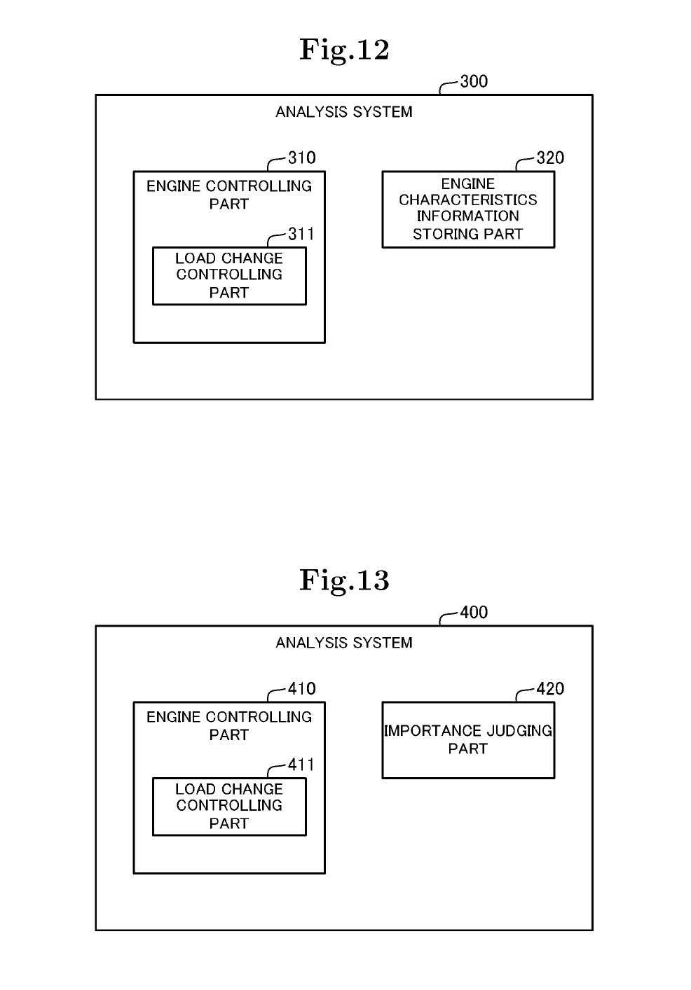

### (Supplementary Note 2-1: see FIG. 12)

An analysis system 300 comprising:

an engine controlling part 310 configured to control an analysis operation of an analysis engine accepting input of analysis target data and executing an analysis process on the analysis target data; and

an engine characteristics information storing part 320 configured to store engine characteristics information representing, for each analysis engine, a relation between analysis accuracy of the analysis engine and a load change process of changing a load on the analysis engine in the analysis process by the analysis engine,

wherein the engine controlling part 310 includes a load change controlling part 311 configured to execute the load change process associated with analysis accuracy of the analysis engine provided in the analysis system, based on the analysis accuracy of the analysis engine, the analysis accuracy being included in the engine characteristics information set for the analysis engine.

### (Supplementary Note 2-2)

The analysis system according to Supplementary Note 2-1, wherein:

the engine characteristics information includes, for each load change process, information in which each of options for the load change process is associated with analysis accuracy of the analysis engine, the options differing in degrees of load change; and

the load change controlling part is configured to execute the load change process corresponding to any of the options for the load change process, based on analysis accuracy of the analysis engine.

### (Supplementary Note 2-3)

The analysis system according to Supplementary Note 2-2, wherein the load change controlling part is configured to execute the load change process corresponding to one of the options that most decreases analysis accuracy of the analysis engine.

### (Supplementary Note 2-4)

The analysis system according to any of Supplementary Notes 2-1 to 2-3, wherein the load change process is a process of reducing a data amount of the analysis target data.

### (Supplementary Note 2-5)

The analysis system according to any of Supplementary Notes 2-1 to 2-4, wherein the load change process is a process of changing the analysis engine analyzing the analysis target data.

### (Supplementary Note 2-6)

The analysis system according to any of Supplementary Notes 2-1 to 2-5, wherein the load change process is a process of changing preprocessing executed on the analysis target data before the analysis engine processes the analysis target data.

### (Supplementary Note 2-7)

A computer program comprising instructions for causing an information processing device to realize an engine controlling part configured to control an analysis operation of an analysis engine accepting input of analysis target data and executing an analysis process on the analysis target data, wherein:

the information processing device includes an engine characteristics information storing part configured to store engine characteristics information representing, for each analysis engine, a relation between analysis accuracy of the analysis engine and a load change process of changing a load on the analysis engine in the analysis process by the analysis engine; and

the engine controlling part includes a load change controlling part configured to execute the load change process associated with analysis accuracy of the analysis engine provided in the analysis system, based on the analysis accuracy of the analysis engine, the analysis accuracy being included in the engine characteristics information set for the analysis engine.

### (Supplementary Note 2-8)

The computer program according to Supplementary Note 2-7, wherein:

the engine characteristics information includes, for each load change process, information in which each of options for the load change process is associated with analysis accuracy of the analysis engine, the options differing in degrees of load change; and

the load change controlling part is configured to execute the load change process corresponding to any of the options for the load change process, based on analysis accuracy of the analysis engine.

### (Supplementary Note 2-9)

An analysis method of accepting input of analysis target data, controlling an operation of an analysis engine, and executing an analysis process on the analysis target data, the analysis method comprising:

based on analysis accuracy included in engine characteristics information that is set for the analysis engine provided in the analysis system and that represents a relation between the analysis accuracy of the analysis engine and a load change process of changing a load on the analysis engine in the analysis process by the analysis engine, executing the load change process associated with the analysis accuracy.

### (Supplementary Note 2-10)

The analysis method according to Supplementary Note 2-9,

wherein the engine characteristics information includes, for each load change process, information in which each of options for the load change process is associated with analysis accuracy of the analysis engine, the options differing in degrees of load change,

the analysis method comprising:

executing the load change process corresponding to any of the options for the load change process, based on analysis accuracy of the analysis engine.

### (Supplementary Note 3-1: see FIG. 13)

An analysis system 400 comprising:

an engine controlling part 410 configured to control an analysis operation of an analysis engine accepting input of analysis target data and executing an analysis process on the analysis target data; and

an importance judging part 420 configured to judge importance of an analysis result produced by a given analysis engine,

wherein the engine controlling part 410 includes a load change controlling part 411 configured to execute a load change process of changing a load on an analysis engine provided in the analysis system in the analysis process by the analysis engine, in accordance with a judgment result produced by the importance judging part.

### (Supplementary Note 3-2)

The analysis system according to Supplementary Note 3-1, comprising an importance judgment criterion storing part configured to store, for each analysis result produced by the analysis engine, importance corresponding to content of the analysis result,

wherein the importance judging part is configured to judge importance of an analysis result produced by a given analysis engine, based on information stored in the importance judgment criterion storing part.

### (Supplementary Note 3-3)

The analysis system according to Supplementary Note 3-1 or 3-2, wherein the load change controlling part is configured to execute the load change process that analysis accuracy of the analysis engine increases as importance of a judgment result produced by the importance judging part is higher, and execute the load change process that a load on the analysis engine decreases as importance of a judgment result produced by the importance judging part is lower.

### (Supplementary Note 3-4)

The analysis system according to any of Supplementary Notes 3-1 to 3-3, wherein the load change process is a process of changing a data amount of the analysis target data.

### (Supplementary Note 3-5)

The analysis system according to any of Supplementary Notes 3-1 to 3-4, wherein the load change process is a process of changing a preset process executed by the analysis engine on the analysis target data.

### (Supplementary Note 3-6)

The analysis system according to Supplementary Note 3-5, wherein the load change process is a process of disabling a preset process executed by the analysis engine on the analysis target data.

### (Supplementary Note 3-7)

A computer program comprising instructions for causing an information processing device to realize:

an engine controlling part configured to control an analysis operation of an analysis engine accepting input of analysis target data and executing an analysis process on the analysis target data; and

an importance judging part configured to judge importance of an analysis result produced by a given analysis engine,

wherein the engine controlling part includes a load change controlling part configured to execute a load change process of changing a load on an analysis engine provided in the analysis system in the analysis process by the analysis engine, in accordance with a judgment result produced by the importance judging part.

### (Supplementary Note 3-8)

The computer program according to Supplementary Note 3-7, wherein:

the information processing device includes an importance judgment criterion storing part configured to store, for each analysis result produced by the analysis engine, importance corresponding to content of the analysis result; and

the importance judging part is configured to judge importance of an analysis result produced by a given analysis engine, based on information stored in the importance judgment criterion storing part.

### (Supplementary Note 3-9)

An analysis method of accepting input of analysis target data, controlling an operation of an analysis engine, and executing an analysis process on the analysis target data,

the analysis method comprising:

judging importance of an analysis result produced by a given analysis engine; and

executing a load change process of changing a load on an analysis engine provided in the analysis system in the analysis process by the analysis engine, in accordance with a result of the judgment.

### (Supplementary Note 3-10)

The analysis method according to Supplementary Note 3-9, comprising:

judging importance of an analysis result produced by a given analysis engine, based on information of importance preset for each analysis result produced by the analysis engine in accordance with content of the analysis result.

The abovementioned computer program is stored in a storage device or recorded on a computer-readable recording medium. For example, the recording medium is a portable medium such as a flexible disk, an optical disk, a magneto-optical disk, and a semiconductor memory.

Although the present invention is described above referring to the exemplary embodiments, the present invention is not limited to the exemplary embodiments. The configurations and details of the present invention can be changed and modified in various manners that can be understood by one skilled in the art within the scope of the present invention.

The present invention is based upon and claims the benefit of priority from Japanese patent application No. 2012-086362, filed on Apr. 5, 2012, the disclosure of which is incorporated herein in its entirety by reference.

### DESCRIPTION OF REFERENCE NUMERALS

1 analysis system
2, 3 engine controlling part
4 analysis process characteristics storing part
5 importance judging part
6 importance judgment rule storing part
11 video acquiring part
12 result outputting part
20, 30 performance control processing part
21, 31 control executing part
22, 32 input data content judging part
23, 33 analyzing part
24, 34 analysis process executing part
25, 35 state judging part
100 analysis system
110 input data
120 analysis engine
121 controlling part
130 analysis result
200, 300, 400 analysis system
210, 310, 410 engine controlling part
211 input data judging part
212, 311, 411 load change controlling part
320 engine characteristics information storing part
420 importance judging part

What is claimed is:

1. An analysis system comprising:
an engine controlling part configured to control an analysis operation of an analysis engine accepting input of analysis target data and executing an analysis process on the analysis target data; and
an importance judging part configured to judge importance of an analysis result produced by a given analysis engine,
wherein the engine controlling part includes a load change controlling part configured to execute a load change process of changing a load on an analysis engine provided in the analysis system in the analysis process by the analysis engine, in accordance with a judgment result produced by the importance judging part.

2. The analysis system according to claim 1, comprising an importance judgment criterion storing part configured to store, for each analysis result produced by the analysis engine, importance corresponding to content of the analysis result,
wherein the importance judging part is configured to judge importance of an analysis result produced by a given analysis engine, based on information stored in the importance judgment criterion storing part.

3. The analysis system according to claim 1, wherein the load change controlling part is configured to execute the load change process that analysis accuracy of the analysis engine increases as importance of a judgment result produced by the importance judging part is higher, and execute the load change process that a load on the analysis engine decreases as importance of a judgment result produced by the importance judging part is lower.

4. The analysis system according to claim 1, wherein the load change process is a process of changing a data amount of the analysis target data.

5. The analysis system according to claim 1, wherein the load change process is a process of changing a preset process executed by the analysis engine on the analysis target data.

6. The analysis system according to claim 5, wherein the load change process is a process of disabling a preset process executed by the analysis engine on the analysis target data.

7. A non-transitory computer-readable medium storing a program comprising instructions for causing an information processing device to realize:
an engine controlling part configured to control an analysis operation of an analysis engine accepting input of analysis target data and executing an analysis process on the analysis target data; and
an importance judging part configured to judge importance of an analysis result produced by a given analysis engine,
wherein the engine controlling part includes a load change controlling part configured to execute a load change process of changing a load on an analysis engine provided in the analysis system in the analysis process by the analysis engine, in accordance with a judgment result produced by the importance judging part.

8. The non-transitory computer-readable medium storing the program according to claim 7, wherein:
the information processing device includes an importance judgment criterion storing part configured to store, for each analysis result produced by the analysis engine, importance corresponding to content of the analysis result; and
the importance judging part is configured to judge importance of an analysis result produced by a given analysis engine, based on information stored in the importance judgment criterion storing part.

9. An analysis method of accepting input of analysis target data, controlling an operation of an analysis engine, and executing an analysis process on the analysis target data,
the analysis method comprising:
judging importance of an analysis result produced by a given analysis engine; and
executing a load change process of changing a load on an analysis engine provided in the analysis system in the analysis process by the analysis engine, in accordance with a result of the judgment.

10. The analysis method according to claim 9, comprising:
judging importance of an analysis result produced by a given analysis engine, based on information of importance preset for each analysis result produced by the analysis engine in accordance with content of the analysis result.
